(19) United States
(12) Patent Application Publication
(10) Pub. No.: US 2013/0069526 A1
(43) Pub. Date: Mar. 21, 2013

(54) PLASMA DISPLAY PANEL

(71) Applicants: Yusuke Nihei, Osaka (JP); Shinichiro Hori, Osaka (JP); Shunsuke Kawai, Osaka (JP); Yoshihiro Sakaguchi, Hyogo (JP)

(72) Inventors: Yusuke Nihei, Osaka (JP); Shinichiro Hori, Osaka (JP); Shunsuke Kawai, Osaka (JP); Yoshihiro Sakaguchi, Hyogo (JP)

(73) Assignee: PANASONIC CORPORATION, Osaka (JP)

(21) Appl. No.: 13/701,717

(22) PCT Filed: Jan. 16, 2012
(86) PCT No.: PCT/JP2012/000199

§ 371 Date: Dec. 3, 2012

(30) Foreign Application Priority Data
Jan. 28, 2011 (JP) 2011-016049

(51) Int. Cl. H01J 17/49

(52) U.S. Cl. CPC H01J 17/492
USPC 313/582

(57) ABSTRACT

A plasma display panel includes a front plate, and a rear plate opposed to the front plate. A discharge gap is provided between a first electrode and a second electrode of the front plate. The first electrode includes first projecting parts projecting from a first base part toward the discharge gap. The second electrode includes projecting parts projecting from a second base part toward the discharge gap. A space between a tip part of the first base part and a tip part of a first bus electrode is 5 μm to 20 μm.

### TECHNICAL FIELD

A technique disclosed herein relates to a plasma display panel used in a display device and the like.

### BACKGROUND ART

A display electrode in a plasma display panel (hereinafter, referred to as a PDP) has a configuration in which a wide and stripe-shaped transparent electrode and a metal bus electrode are laminated. In order to suppress a discharge current, or in order to reduce the number of steps by not providing a transparent electrode, a display electrode which is divided into a plurality of parts and having an opening part is used (refer to PTL 1, for example).

### CITATION LIST

### Patent Literature

PTL1: International Publication No. 02/017345

### SUMMARY OF THE INVENTION

A PDP includes a front plate, and a rear plate provided so as to be opposed to the front plate. The front plate further has a first electrode, and a second electrode provided parallel to the first electrode. A discharge gap is provided between the first electrode and the second electrode. The first electrode includes a first transparent electrode and a first bus electrode provided on the first transparent electrode. The second electrode includes a second transparent electrode and a second bus electrode provided on the second transparent electrode. The first transparent electrode includes a first base part and a plurality of first projecting parts projecting from the first base part toward the discharge gap. The second transparent electrode includes a second base part and a plurality of second projecting parts projecting from the second base part toward the discharge gap. A space between a tip part of the first base part on a side of the discharge gap and a tip part of the first bus electrode on the side of the discharge gap is 5 μm to 20 μm. A space between a tip part of the second base part on the side of the discharge gap and a tip part of the second bus electrode on the side of the discharge gap is 5 μm to 20 μm.

### BRIEF DESCRIPTION OF THE DRAWINGS

FIG. 1 is an exploded perspective view showing a PDP.

FIG. 2 is a cross-sectional view showing a configuration of a discharge cell part of the PDP.

FIG. 3 is an electrode arrangement view of the PDP.

FIG. 4 is a plan view showing an arrangement relationship between a scan electrode and a sustain electrode, and a barrier rib.

FIG. 5 is a plan view showing an arrangement relationship between a scan electrode and a sustain electrode, and a bus electrode in a first exemplary embodiment.

FIG. 6 is a plan view showing an arrangement relationship between a scan electrode and a sustain electrode, and a bus electrode in a second exemplary embodiment.

FIG. 7 is a view showing a relationship between film thicknesses of transparent electrodes of the scan electrode and the sustain electrode, and a sustain voltage difference.

FIG. 8 is a view showing yellowing levels of the PDP.

FIG. 9 is a block diagram showing an entire configuration of a plasma display device provided with the PDP according to the exemplary embodiment.

FIG. 10 is a waveform chart showing a drive voltage waveform to be applied to each electrode of the PDP.

### DESCRIPTION OF EMBODIMENTS

### First Exemplary Embodiment

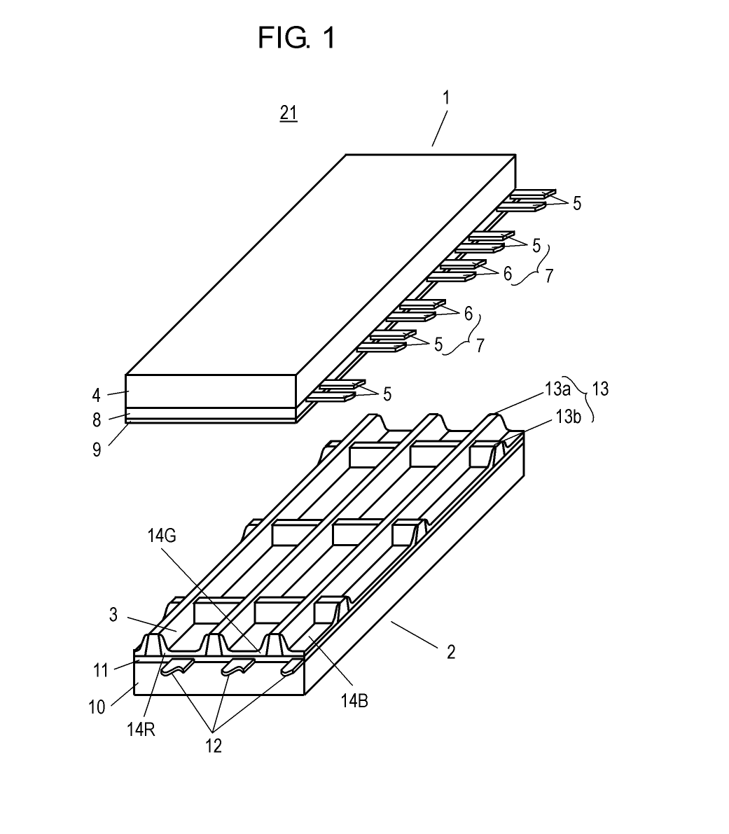

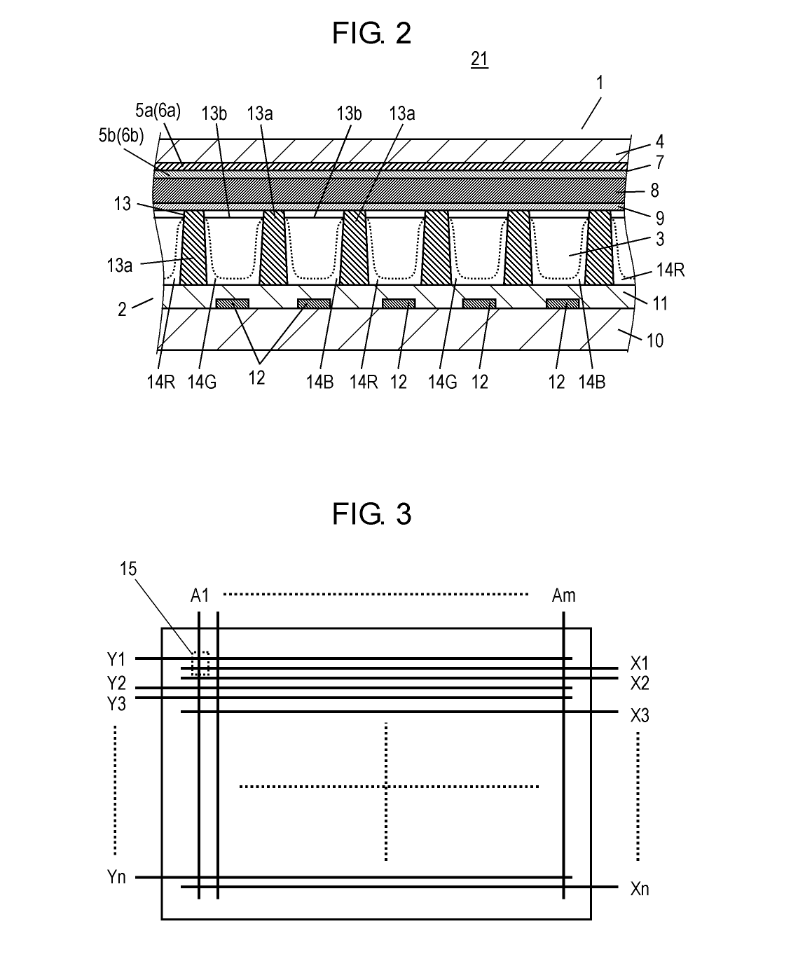

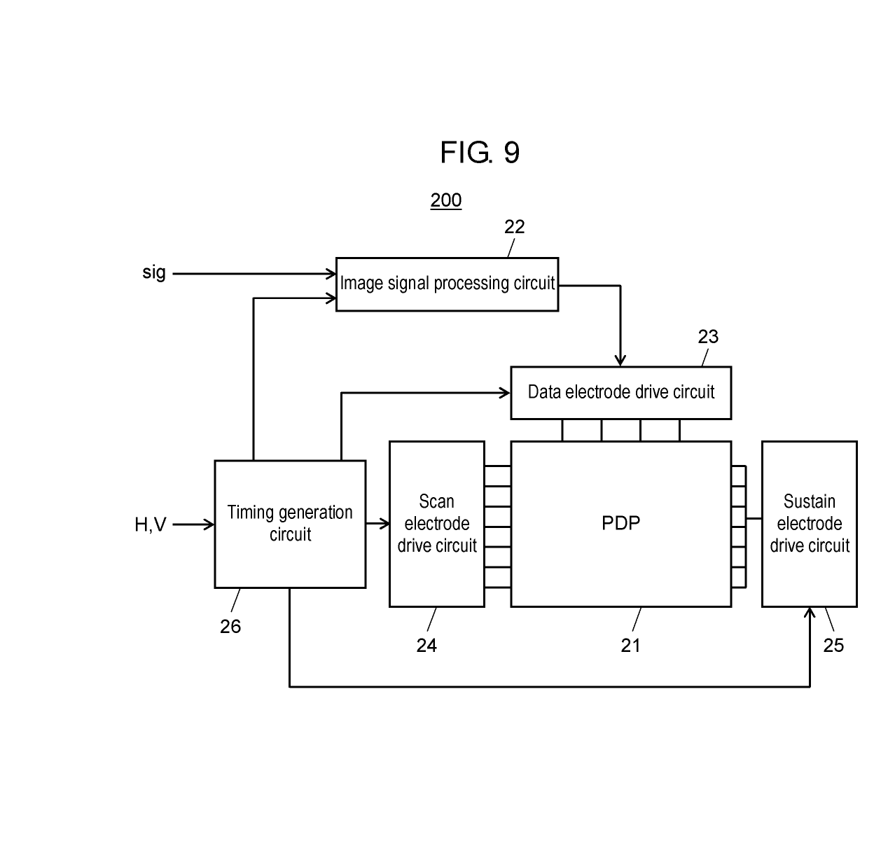

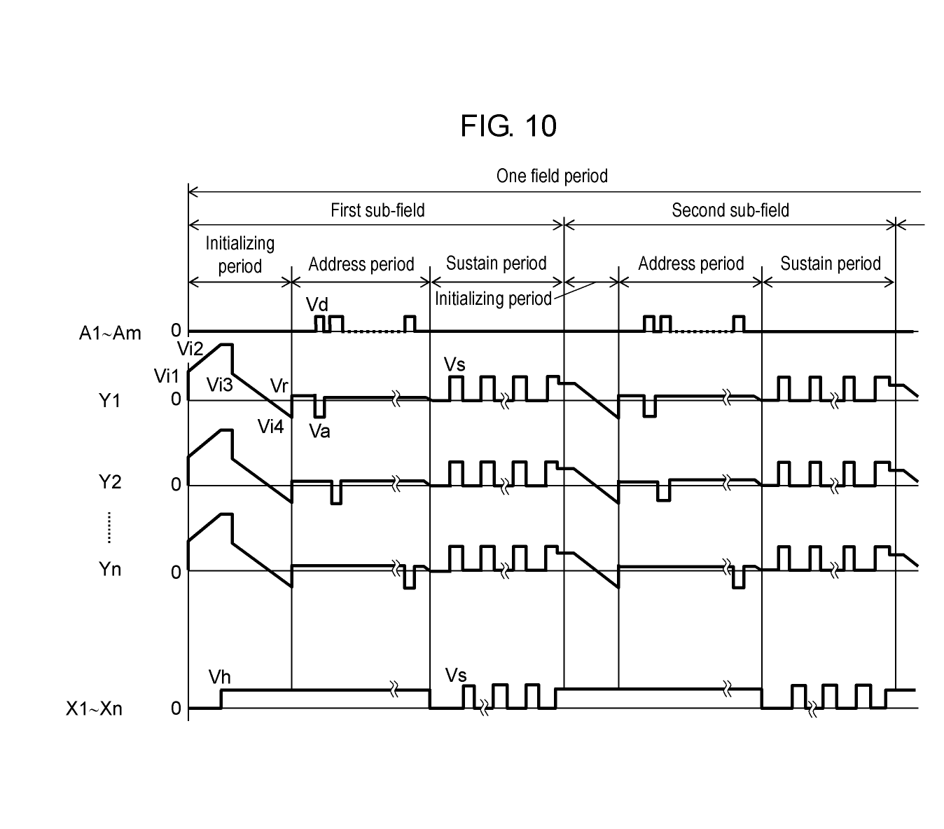

Hereinafter, a PDP according to a first exemplary embodiment will be described with reference to FIG. 1 through FIG. 4, FIG. 9, and FIG. 10. However, an exemplary embodiment of the present invention is not limited to the first exemplary embodiment.

### 1. CONFIGURATION OF PDP 21

As shown in FIG. 1, PDP 21 includes front plate 1 and rear plate 2. Front plate 1 and rear plate 2 are arranged to be opposed to each other with discharge space 3 provided therebetween.

Front plate 1 includes front substrate 4, display electrode 7, dielectric layer 8, and protective film 9. Conductive display electrodes 7 are arranged on front substrate 4 made of glass. Display electrode 7 includes scan electrode 5 and sustain electrode 6. Scan electrode 5 includes transparent electrode 5a and bus electrode 5b. Sustain electrode 6 includes transparent electrode 6a and bus electrode 6b. Scan electrode 5 and sustain electrode 6 are arranged parallel to each other with a discharge gap provided therebetween. Dielectric layer 8 made of a glass material is formed so as to cover scan electrode 5 and sustain electrode 6. Protective film 9 made of a magnesium oxide (MgO) is formed on dielectric layer 8.

As shown in FIG. 1, rear plate 2 includes rear substrate 10, insulating layer 11, data electrode 12, barrier rib 13, and phosphor layers 14R, 14G, and 14B. Data electrodes 12 made of Ag are provided on rear substrate 10 formed of glass. Data electrode 12 is covered with insulating layer 11 formed of a glass material. Parallel-cross barrier rib 13 formed of a glass material is provided on insulating layer 11. Barrier rib 13 includes vertical barrier rib 13a and horizontal barrier rib 13b. Vertical barrier rib 13a is formed parallel to data electrode 12. Horizontal barrier rib 13b is formed so as to intersect with vertical barrier rib 13a. Barrier rib 13 divides discharge space 3 formed between front plate 1 and rear plate 2 with respect to each discharge cell 15 (refer to FIG. 3). Each of phosphor layers 14R, 14G, and 14B for red (R), green (G), and blue (B), respectively is provided on a surface of insulating layer 11 and a side surface of barrier rib 13.

Phosphor layers 14R, 14G, and 14B are applied to a space in barrier rib 13 in a striped manner along vertical barrier rib 13a. Phosphor layers 14R, 14G, and 14B are provided such that phosphor layer 14B emitting blue light, phosphor layer 14R emitting red light, and phosphor layer 14G emitting green light are arranged in this order.

Thus, front plate 1 and rear plate 2 are oppositely arranged such that scan electrode 5 and sustain electrode 6 intersect with data electrode 12. As shown in FIG. 3, discharge cell 15 is provided at an intersection region between scan electrode 5 and sustain electrode 6, and data electrode 12. A mixed gas of neon and xenon is sealed in discharge space 3 as a discharge gas. In addition, a structure of PDP 21 is not limited to the one described above. The structure of PDP 21 may have striped barrier rib 13.

As shown in FIG. 3, scan electrode 5 includes n scan electrodes Y1, Y2, Y3 . . . Yn extending in a row direction. Sustain electrode 6 includes n sustain electrodes X1, X2, X3, . . . Xn extending in the row direction. Data electrode 12 includes m data electrodes A1, . . . Am extending in a column direction. Discharge cell 15 is provided at an intersection of one pair of scan electrode Yp and sustain electrode Xp (1≦p≦n), and one data electrode Aq (1≦q≦m). Thus, m×n discharge cells 15 are formed in discharge space 3. Scan electrodes 5 and sustain electrodes 6 are formed in front plate 1 in patterns where scan electrode Y1, sustain electrode X1, sustain electrode X2, scan electrode Y2, . . . are arranged. Each of scan electrode 5 and sustain electrode 6 is connected to a terminal of a drive circuit provided outside the image display region in which discharge cells 15 are formed.

### 2. CONFIGURATION AND DRIVE OF PDP DEVICE

Next, a description will be given of an entire configuration of plasma display device 200 having above-described PDP 21 and a method for driving the same.

As shown in FIG. 9, plasma display device 200 is provided with PDP 21 having the configuration shown in FIG. 1 through FIG. 4, image signal processing circuit 22, data electrode drive circuit 23, scan electrode drive circuit 24, sustain electrode drive circuit 25, timing generation circuit 26, and a power supply circuit (not shown). Data electrode drive circuit 23 is connected to one end part of data electrode 12 of PDP 21. Data electrode drive circuit 23 has a plurality of data drivers each composed of a semiconductor element for supplying a voltage to data electrode 12. Data electrodes 12 are divided into a plurality of blocks in which one block is composed of several data electrodes 12. Data drivers provided for respective blocks of data electrode 12 are connected to an electrode interconnect part provided in a lower end part of PDP 21.

Referring to FIG. 9, image signal processing circuit 22 converts image signal sig to image data with respect to each sub-field. Data electrode drive circuit 23 converts the image data of each sub-field to a signal corresponding to each of data electrodes A1 to Am, and drives each of data electrodes A1 to Am. Timing generation circuit 26 generates various kinds of timing signals based on horizontal synchronizing signal H and vertical synchronizing signal V, and supplies the various kinds of timing signals to each drive circuit block. Scan electrode drive circuit 24 supplies a drive voltage waveform to scan electrodes Y1 to Yn based on the timing signal. Sustain electrode drive circuit 25 supplies a drive voltage waveform to sustain electrodes X1 to Xn based on the timing signal. In addition, one ends of the sustain electrodes are mutually connected in PDP 21 or outside PDP 21, and the mutually connected wiring is connected to sustain electrode drive circuit 25.

### 3. DRIVE OF PLASMA DISPLAY DEVICE 200

Next, a description will be given of the drive voltage waveform for driving PDP 21 and its operation with reference to FIG. 10.

According to PDP 21 in the first exemplary embodiment, the one field is divided into the sub-fields, and each sub-field has an initializing period, an address period, and a sustain period.

### 3-1. Initializing Period

In the initializing period of the first sub-field, data electrodes A1 to Am and sustain electrodes X1 to Xn are held at 0 (V). Scan electrodes Y1 to Yn receive a ramp voltage which gradually rises from voltage Vi1 (V) which is below a discharge start voltage to voltage Vi2 (V) which is above the discharge start voltage. Then, a first weak initializing discharge is generated in all of discharge cells 15, and a negative wall voltage is stored on scan electrodes Y1 to Yn. In addition, a positive wall voltage is stored on sustain electrodes X1 to Xn, and data electrodes A1 to Am. Here, the wall voltage on the electrode means a voltage generated by wall charges accumulated on the dielectric layer and the phosphor layer which cover the electrodes.

After that, sustain electrodes X1 to Xn are held at positive voltage Vh (V), and scan electrodes Y1 to Yn receive a ramp voltage which gradually falls from voltage Vi3 (V) to voltage Vi4 (V). Then, a second weak initializing discharge is generated in all of discharge cells 15. Thus, the wall voltage between scan electrodes Y1 to Yn and sustain electrodes X1 to Xn is weakened and adjusted to a value suitable for an address operation. The wall voltage on data electrodes A1 to Am is also adjusted to a value suitable for the address operation.

### 3-2. Address Period

In the following address period, scan electrodes Y1 to Yn are held at Vr (V) once. Then, negative scan pulse voltage Va (V) is applied to scan electrode Y1 in a first row. In addition, positive address pulse voltage Vd (V) is applied to data electrode Ak (k=1 to m) of discharge cell 15 to be displayed in the first row among data electrodes A1 to Am. At this time, a voltage at an intersection part between data electrode Ak and scan electrode Y1 is given by adding the wall voltage on data electrode Ak and the wall voltage on scan electrode Y1 to an externally applied voltage (Vd−Va) (V), and this voltage exceeds the discharge start voltage. Thus, an address discharge is generated between data electrode Ak and scan electrode Y1 and between sustain electrode X1 and scan electrode Y1. Thus, the positive wall voltage is stored on scan electrode Y1 of discharge cell 15, and the negative wall voltage is stored on sustain electrode X1. At this time, the negative wall voltage is stored on data electrode Ak also.

Thus, the address discharge is generated in discharge cell 15 to be displayed in the first row, and the address operation is performed such that the wall voltage is stored on each electrode. Meanwhile, since the voltage at the intersection parts of data electrodes A1 to Am to which address pulse voltage Vd (V) is not applied and scan electrode Y1 does not exceed the discharge start voltage, the address discharge is not generated. The above address operation is sequentially performed until discharge cell 15 in an n-th row, and the address period is completed.

### 3-3. Sustain Period

In the following sustain period, positive sustain pulse voltage Vs (V) is applied to scan electrodes Y1 to Yn as a first voltage. A ground potential, that is, 0 (V) is applied to sustain electrodes X1 to Xn as a second voltage. At this time, as for discharge cell 15 in which the address discharge has been generated, the voltage applied between scan electrode Yi (i=1 to n) and sustain electrode Xi is given by adding the wall voltage on scan electrode Yi and the wall voltage on sustain electrode Xi to sustain pulse voltage Vs (V), and this voltage exceeds the discharge start voltage. Thus, the sustain discharge is generated between scan electrode Yi and sustain electrode Xi, and ultraviolet light generated at this time allows the phosphor layer to emit light. Thus, the negative wall voltage is stored on scan electrode Yi, and the positive wall voltage is stored on sustain electrode Xi. At this time, the positive wall voltage is also stored on data electrode Ak.

As for discharge cell 15 in which the address discharge has not been generated in the address period, the sustain discharge is not generated, and the wall voltage at the time of the end of the initializing period is held. Then, the second voltage of 0 (V) is applied to scan electrodes Y1 to Yn. The first voltage of sustain pulse voltage Vs (V) is applied to sustain electrodes X1 to Xn. Then, as for discharge cell 15 in which the sustain discharge has been generated, the voltage between sustain electrode Xi and scan electrode Yi exceeds the discharge start voltage, so that the sustain discharge is generated between sustain electrode Xi and scan electrode Yi again. Thus, the negative wall voltage is stored on sustain electrode Xi, and the positive wall voltage is stored on scan electrode Yi.

### 3-4. Following Second Sub-Field

Similarly, the sustain pulse whose number corresponds to a luminance weight is applied to scan electrodes Y1 to Yn and sustain electrodes X1 to Xn alternately, so that the sustain discharge is continuously generated in discharge cell 15 in which the address discharge has been generated in the address period. Thus, the sustain operation in the sustain period is completed. Since operations in the initializing period, the address period, and the sustain period in the following sub-field are roughly the same as those in the first sub-field, a description therefore is omitted.

### 4. METHOD FOR PRODUCING PDP 21

### 4-1. Method for Producing Front Plate 1

Scan electrode 5 and sustain electrode 6 are formed on front substrate 4 by a photolithography method. Scan electrode 5 includes transparent electrode 5a formed of an indium tin oxide (ITO) or the like, and bus electrode 5b formed of silver (Ag) or the like and laminated on transparent electrode 5a. Sustain electrode 6 includes transparent electrode 6a formed of ITO or the like, and bus electrode 6b formed of Ag or the like and laminated on transparent electrode 6a. A material of bus electrodes 5b and 6b includes an electrode paste containing silver (Ag), a glass frit to bind the silver, a photosensitive resin, a solvent, or the like. First, the electrode paste is applied to front substrate 4 on which transparent electrodes 5a and 6a have been formed, by a screen printing method. Then, the solvent in the electrode paste is removed in a baking oven. Then, the electrode paste is exposed through a photomask having a predetermined pattern.

Then, the electrode paste is developed, whereby a bus electrode pattern is formed. Finally, the bus electrode pattern is baked at a predetermined temperature in the baking oven. That is, the photosensitive resin in the electrode pattern is removed. In addition, the glass frit in the electrode pattern is melted. After that, the molten glass frit is vitrified when cooled down to room temperature. Through the above steps, bus electrodes 5b and 6b are formed. Here, other than the method for applying the electrode paste by the screen printing, a sputtering method, or a vapor deposition method may be used.

Then, dielectric layer 8 is formed. A material of dielectric layer 8 includes a dielectric paste containing a dielectric glass frit, a resin, a solvent, and the like. First, the dielectric paste is applied onto front substrate 4 by a die coating method and the like so as to cover scan electrode 5 and sustain electrode 6 with a predetermined thickness. Then, the solvent in the dielectric paste is removed in the baking oven. Finally, the dielectric paste is baked at a predetermined temperature in the baking oven. That is, the resin in the dielectric paste is removed. In addition, the dielectric glass frit is melted. Then, the molten dielectric glass frit is vitrified when cooled down to room temperature. Through the above steps, dielectric layer 8 is formed. Here, other than the method for applying the dielectric paste by die coating, the screen printing method or a spin coating method may be used. In addition, without using the dielectric paste, a film used as dielectric layer 8 can be formed by a CVD (Chemical Vapor Deposition) method and the like. Then, protective film 9 is formed on dielectric layer 8.

Through the above steps, front plate 1 is completed such that scan electrode 5, sustain electrode 6, and dielectric layer 8, and protective film 9 are formed on front substrate 4.

### 4-2. Method for Producing Rear Plate 2

Data electrode 12 is formed on rear substrate 10 by the photolithography method. A material of data electrode 12 includes a data electrode paste containing silver (Ag) to ensure conductivity, a glass frit to bind the silver, a photosensitive resin, a solvent, and the like. First, the data electrode paste is applied to rear substrate 10 so as to have a predetermined thickness, by the screen printing method. Then, the solvent in the data electrode paste is removed in the baking oven. Then, the data electrode paste is exposed through a photomask having a predetermined pattern. Then, the data electrode paste is developed, whereby a data electrode pattern is formed. Finally, the data electrode pattern is baked at a predetermined temperature in the baking oven. That is, the photosensitive resin in the data electrode pattern is removed. In addition, the glass frit in the data electrode pattern is melted. After that, the molten glass frit is vitrified when cooled down to room temperature. Through the above steps, data electrode 12 is formed. Here, other than the method for applying the data electrode paste by the screen printing, the sputtering method, or the vapor deposition method may be used.

Then, insulating layer 11 is formed. A material of insulating layer 11 includes an insulating paste containing an insulating glass frit, a resin, a solvent, and the like. First, the insulating paste is applied onto rear substrate 10 on which data electrode 12 has been formed, by the screen printing method so as to cover data electrode 12 with a predetermined thickness. Then, the solvent in the insulating paste is removed in the baking oven. Finally, the insulating paste is baked at a predetermined temperature in the baking oven. That is, the resin in the insulating paste is removed. In addition, the insulating glass frit is melted. Then, the molten insulating glass frit is vitrified when cooled down to room temperature. Through the above steps, insulating layer 11 is formed. Here, other than the method for applying the insulating paste by screen printing, the die coating method or the spin coating method may be used. In addition, without using the insulating paste, a film used as insulating layer 11 can be formed by the CVD (Chemical Vapor Deposition) method.

Then, barrier rib 13 is formed by the photolithography method. A material of barrier rib 13 includes a barrier rib paste containing a filler, a glass frit to bind the filler, a photosensitive resin, a solvent, or the like. First, the barrier rib paste is applied onto insulating layer 11 by the die coating method so as to have a predetermined thickness. Then, the solvent in the barrier rib paste is removed in the baking oven. Then, the barrier rib paste is exposed through a photomask having a predetermined pattern. Then, the barrier rib paste is developed, whereby a barrier rib pattern is formed. Finally, the barrier rib pattern is baked at a predetermined temperature in the baking oven. That is, the photosensitive resin in the barrier rib pattern is removed. In addition, the glass frit in the barrier rib pattern is melted. Then, the molten glass frit is vitrified when cooled down to room temperature. Through the above steps, barrier rib 13 is formed. Here, other than the photolithography method, a sandblasting method may be used.

Then, phosphor layers 14R, 14B, and 14G are formed. A material of phosphor layers 14R, 14B, and 14G includes a phosphor paste containing phosphor particles, a binder, a solvent, and the like. First, the phosphor paste is applied by a dispensing method onto insulating layer 11 provided between adjacent barrier ribs 13 and the side surface of barrier rib 13 so as to have a predetermined thickness. Then, the solvent in the phosphor paste is removed in the baking oven. Finally, the phosphor paste is baked at a predetermined temperature in the baking oven. That is, the resin in the phosphor paste is removed. Through the above steps, phosphor layers 14R, 14B, and 14G are formed. Here, other than the dispensing method, the screen printing method may be used.

Through the above steps, rear plate 2 is completed such that data electrode 12, insulating layer 11, barrier rib 13, and phosphor layers 14R, 14B, and 14G are formed on rear substrate 10.

### 4-3. Method for Assembling Front Plate 1 and Rear Plate 2

A sealing paste is applied to a periphery of rear plate 2 by the dispensing method. The sealing paste may contain beads, a low-melting-point glass material, a binder, a solvent, and the like. The applied sealing paste is formed into a sealing paste layer (not shown). Then, the solvent in the sealing paste layer is removed in the baking oven. Then, the sealing paste layer is temporarily baked at a temperature of about 350° C. The resin component in the sealing paste layer is removed by this temporary firing. Then, front plate 1 and rear plate 2 are oppositely arranged such that display electrode 7 and data electrode 12 intersect with each other.

Furthermore, peripheral parts of front plate 1 and rear plate 2 are held while being pressed by a clip. In this state, the peripheral parts are baked at a predetermined temperature, and the low-melting-point glass material is melted. Then, the molten low-melting-point glass is vitrified when cooled down to room temperature. Thus, front plate 1 and rear plate 2 are hermetically sealed. Finally, the discharge gas containing Ne, Xe, or the like is sealed in the discharge space, whereby PDP 21 is completed.

### 5. DISPLAY ELECTRODE

### 5-1. Detailed Structure of Transparent Electrodes 5a and 6a

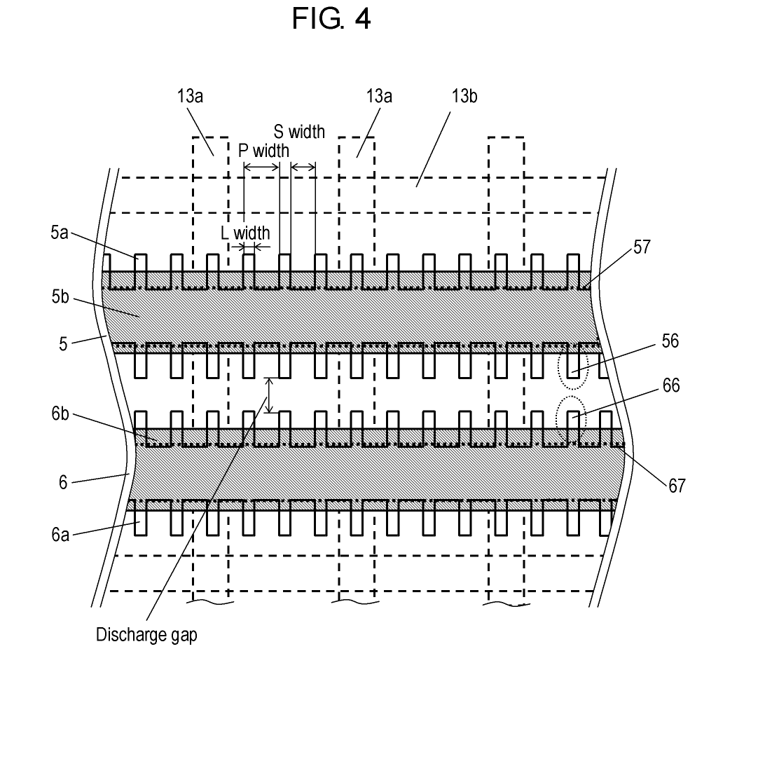

As shown in FIG. 4, transparent electrode 5a includes second transparent electrode region 57 extending in the same direction as the extending direction of bus electrode 5b, and first transparent electrode region 56 projecting from second transparent electrode region 57 toward the discharge gap. First transparent electrode region 56 is parallel to vertical barrier rib 13a, as one example.

Second transparent electrode region 57 is rectangular, as one example. First transparent electrode region 56 is rectangular, as one example.

As shown in FIG. 4, transparent electrode 6a includes second transparent electrode region 67 extending in the same direction as the extending direction of bus electrode 6b, and first transparent electrode region 66 projecting from second transparent electrode region 67 toward the discharge gap. First transparent electrode region 66 is parallel to vertical barrier rib 13a, as one example.

Second transparent electrode region 67 is rectangular, as one example. First transparent electrode region 66 is rectangular, as one example.

In discharge cell 15, the discharge gap is provided between a tip part of first transparent electrode region 56 of scan electrode 5, and a tip part of first transparent electrode region 66 of sustain electrode 6.

In addition, multiple first transparent electrode regions 56 and 66 are preferably provided in one discharge cell 15. This is because the discharge becomes more stable.

Here, a description will be given of a result of an experiment executed by the present inventors. In addition, in this experiment, two parameters are used. A first parameter is a width (shown as “L width” below and in the drawing) of first transparent electrode regions 56 and 66 opposed to each other across the discharge gap. A second parameter is a width (shown as “S width” below and in the drawing) between adjacent first transparent electrode regions 56 in scan electrode 5, or a width between adjacent first transparent electrode regions 66 in sustain electrode 6.

Based on changes of L width and S width, one paired width (shown as “P width” below and in the drawing) serving as a sum of L width and S width is changed. In addition, when P width is changed, the number of pairs provided in one discharge cell 15 is changed.

According to the electrode structure shown in FIG. 4, first transparent electrode regions 56 and 66 each having L width of 14 μm are divided into a plurality of parts and arranged at intervals of S width of 15 μm. In this case, compared with a case where first transparent electrode regions 56 and 66 are each formed without being divided, emission efficiency can be improved by about 10%. In addition, first transparent electrode regions 56 and 66 each having L width of 20 μm are divided into a plurality of parts and arranged at intervals of S width of 20 μm. In this case also, compared with the case where first transparent electrode regions 56 and 66 are each formed without being divided, emission efficiency can be improved by about 10%.

Furthermore, a sample in which first transparent electrode regions 56 and 66 each having L width of 14 μm are arranged at intervals of S width of 15 μm or more has been evaluated. Compared with emission efficiency in a sample in which a first transparent electrode region is formed without being divided, it has been found that emission efficiency can be more improved by setting the interval to be larger than a film thickness of dielectric layer 8.

In addition, although not shown, as another example of an arrangement relationship between scan electrode 5 and sustain electrode 6 of display electrode 7, and barrier rib 13, first transparent electrode region 56 of scan electrode 5 and first transparent electrode region 66 of sustain electrode 6 may be alternately opposed to each other.

### 5-2. Relationship Between Film Thickness of Transparent Electrode and Sustain Voltage

PDP 21 having first transparent electrode regions 56 and 66 divided into the multiple parts as shown in FIG. 4 is high in sustain pulse voltage Vs, compared with PDP 21 having transparent electrodes 5a and 6a provided without being divided. This is because face-to-face capacity is low, and electric charge is not likely to be stored.

In addition, thinning transparent electrodes 5a and 6a is one means for reducing cost of PDP 21. However, when transparent electrodes 5a and 6a are thinned, contact resistance between bus electrodes 5b and 6b, and transparent electrodes 5a and 6a rapidly increases, respectively. As a result, sustain pulse voltage Vs further increases.

In addition, as for PDP 21 having first transparent electrode regions 56 and 66 divided into the multiple parts, there is an increase in direct contact area between bus electrodes 5b and 6b, and front substrate 4. As a result, Sn or the like contained in front substrate 4 is in contact with Ag or the like contained in bus electrodes 5b and 6b. As a result, PDP 21 turns yellow.

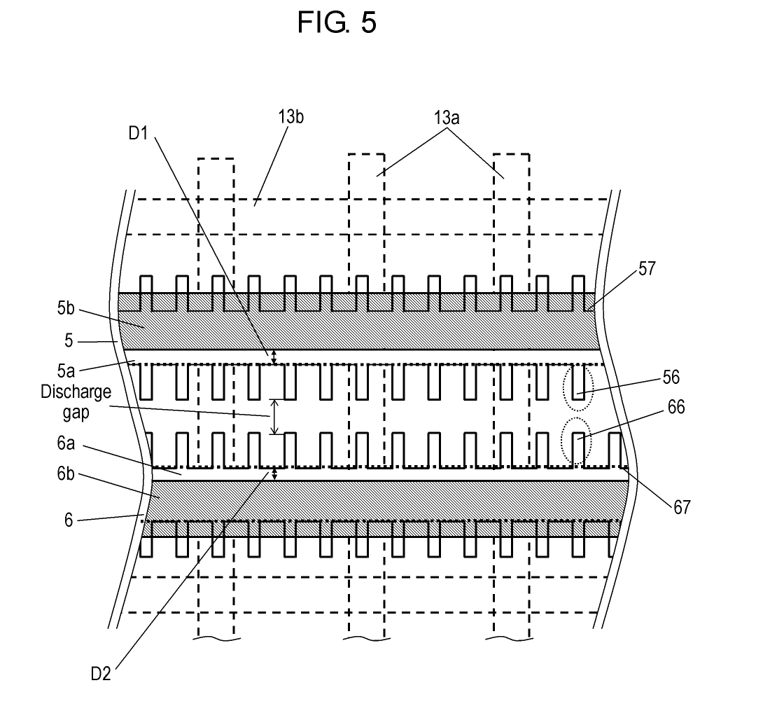

Therefore, as shown in FIG. 5, according to this exemplary embodiment, transparent electrode 5a includes second transparent electrode region 57 extending in the same direction as the extending direction of bus electrode 5b, and first transparent electrode region 56 projecting from second transparent electrode region 57 toward the discharge gap. First transparent electrode region 56 is parallel to vertical barrier rib 13a, as one example. Second transparent electrode region 57 is rectangular, as one example. First transparent electrode region 56 is rectangular, as one example. Transparent electrode 6a includes second transparent electrode region 67 extending in the same direction as the extending direction of bus electrode 6b, and first transparent electrode region 66 projecting from second transparent electrode region 67 toward the discharge gap. First transparent electrode region 66 is parallel to vertical barrier rib 13a, as one example.

Second transparent electrode region 67 is rectangular, as one example. First transparent electrode region 66 is rectangular, as one example. In discharge cell 15, discharge gap is provided between a tip part of first transparent electrode region 56 and a tip part of first transparent electrode region 66. Space D1 between a tip part of second transparent electrode region 57 on the side of the discharge gap and a tip part of bus electrode 5b on the side of the discharge gap is 5 μm to 20 μm. Furthermore, space D2 between a tip part of second transparent electrode region 67 on the side of the discharge gap and a tip part of bus electrode 6b on the side of the discharge gap is 5 μm to 20 μm.

In addition, multiple first transparent electrode regions 56 and 66 are preferably provided in one discharge cell. This is because the discharge becomes more stable.

As shown in FIG. 5, second transparent electrode regions 57 and 67 project from bus electrodes 5b and 6b, respectively, and are opposed to each other across the discharge gap. Thus, contact resistance between bus electrode 5b and transparent electrode 5a, and contact resistance between bus electrode 6b and transparent electrode 6a are inhibited. That is, according to the configuration shown in FIG. 5, sustain pulse voltage Vs becomes lower, compared with the configuration in which second transparent electrode regions 57 and 67 do not project from bus electrodes 5b and 6b toward the discharge gap, respectively.

In addition, according to this exemplary embodiment, the direct contact area between bus electrodes 5b and 6b, and front substrate 4 is small compared with the configuration in which second transparent electrode regions 57 and 67 do not project from bus electrodes 5b and 6b toward the discharge gap, respectively. That is, the contact area between Sn or the like contained in front substrate 4 and Ag or the like contained in bus electrodes 5b and 6b can become smaller. As a result, PDP 21 can be prevented from turning yellow.

### Second Exemplary Embodiment

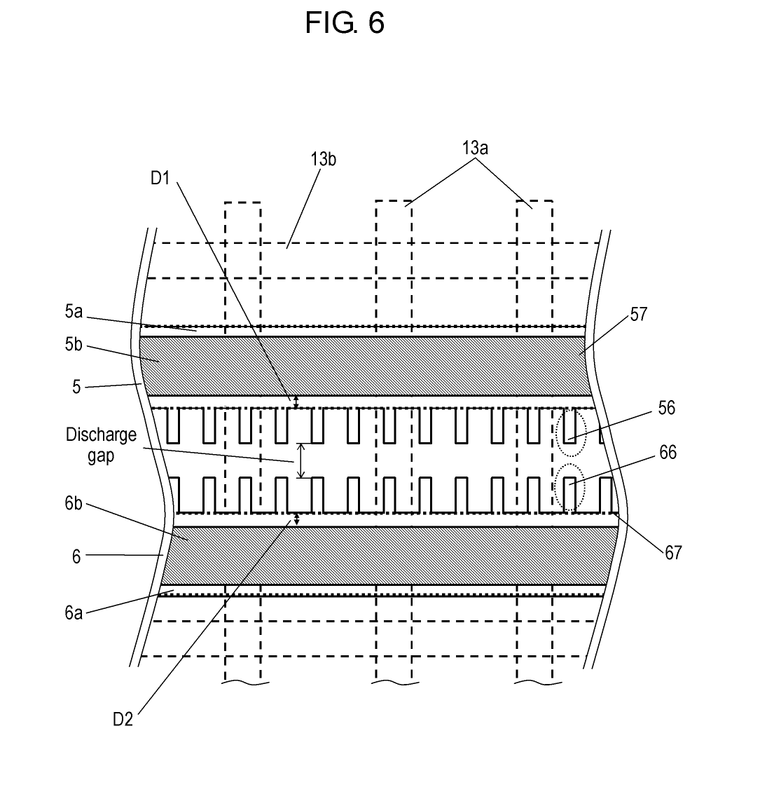

As shown in FIG. 6, space D1 between a tip part of second transparent electrode region 57 on a side of a discharge gap in transparent electrode 5a, and a tip part of bus electrode 5b on the side of the discharge gap is 5 μm to 20 μm. Furthermore, space D2 between a tip part of second transparent electrode region 67 on the side of the discharge gap in transparent electrode 6a, and a tip part of bus electrode 6b on the side of the discharge gap is 5 μm to 20 μm. In addition, first transparent electrode regions 56 and 66 divided into the multiple parts are not provided on an opposite side of the discharge gap, that is, on a side of an IPG (Inter Pixel Gap).

Thus, as shown in FIG. 6, bus electrode 5b is provided on second transparent electrode region 57 in scan electrode 5, and not in contact with front substrate 4. Bus electrode 6b is provided on second transparent electrode region 67 in sustain electrode 6, and not in contact with front substrate 4. Thus, PDP 21 can be further prevented from turning yellow.

### (Evaluation)

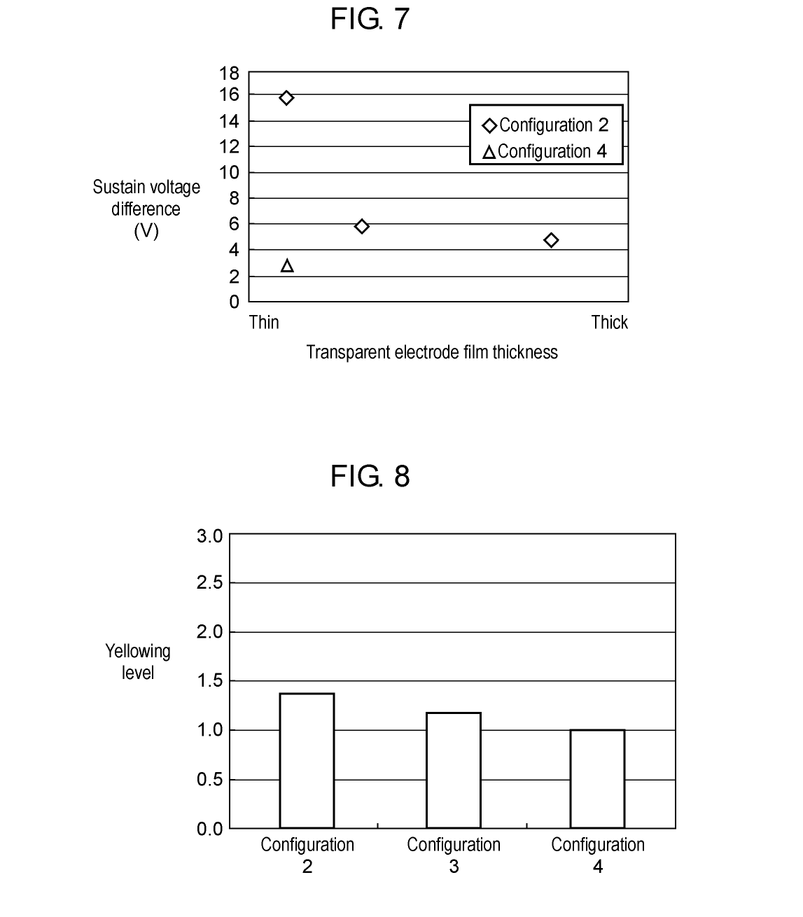

A description will be given in detail of an influence of sustain voltage on yellowing of the PDP in the first exemplary embodiment and the second exemplary embodiment with reference to FIG. 7 and FIG. 8.

According to configuration 1, the PDP has transparent electrodes 5a and 6a which do not include first transparent electrode regions 56 and 66, respectively.

According to configuration 2, the PDP has transparent electrodes 5a and 6a which include first transparent electrode regions 56 and 66 and second transparent electrode regions 57 and 67 (for example, shown in FIG. 4), respectively. Bus electrodes 5b and 6b cover second transparent electrode regions 57 and 67, respectively. Furthermore, bus electrodes 5b and 6b partially cover first transparent electrode regions 56 and 66, respectively.

According to configuration 3, the PDP has the configuration of the first exemplary embodiment (for example, shown in FIG. 5).

According to configuration 4, the PDP has the configuration of the second exemplary embodiment (for example, shown in FIG. 6).

### 6-1. Sustain Pulse Voltage Vs

As shown in FIG. 7, a horizontal axis shows film thicknesses of transparent electrodes 5a and 6a. A vertical axis shows a sustain voltage difference (V) based on a sustain pulse voltage in configuration 1. A sustain voltage difference (V) in configuration 2 is given by subtracting a sustain pulse voltage required to correctly turn on configuration 1 from a sustain pulse voltage required to correctly turn on configuration 2.

A sustain voltage difference (V) in configuration 4 is given by subtracting the sustain pulse voltage required to correctly turn on configuration 1 from a sustain pulse voltage required to correctly turn on configuration 4.

According to configuration 2, as the film thicknesses of transparent electrodes 5a and 6a become small, the sustain voltage difference with respect to configuration 1 becomes large. That is, in the case of configuration 2, as the film thicknesses of transparent electrodes 5a and 6a become small, sustain pulse voltage Vs becomes high.

Meanwhile, according to configuration 4, even when the film thicknesses of transparent electrodes 5a and 6a become small, the sustain voltage difference with respect to configuration 1 is extremely smaller than that of configuration 2. That is, according to configuration 4, sustain pulse voltage Vs can be smaller than that of configuration 2.

### 6-2. Yellowing

The yellowing is evaluated by visually observing PDP 21. As shown in FIG. 8, a yellowing level of configuration 2 is larger than those of configuration 3 and configuration 4. In addition, in FIG. 8, the yellowing levels of configuration 2 and configuration 3 are shown as relative values with respect to the yellowing level of configuration 4 serving as a reference value.

According to configuration 3 and configuration 4, an area in which Sn or the like contained in front substrate 4 is contact with Ag or the like contained in bus electrodes 5b and 6b is smaller than that of configuration 2. Therefore, the yellowing of PDP 21 is suppressed in configuration 3 and configuration 4, compared with that of configuration 2.

Furthermore, the yellowing level of configuration 4 is smaller than that of configuration 3. According to configuration 4, the area in which Sn or the like contained in front substrate 4 is contact with Ag or the like contained in bus electrodes 5b and 6b is smaller than that of configuration 3. Therefore, the yellowing of PDP 21 is suppressed in configuration 4, compared with that of configuration 3.

### 7. CONCLUSION

PDP 21 disclosed herein includes front plate 1, and rear plate 2 provided so as to be opposed to front plate 1. Front plate 1 has scan electrode 5 serving as the first electrode, and sustain electrode 6 serving as the second electrode provided parallel to scan electrode 5. The discharge gap is provided between scan electrode 5 and sustain electrode 6. Scan electrode 5 includes transparent electrode 5a serving as the first transparent electrode, and bus electrode 5b serving as the first bus electrode provided on transparent electrode 5a. Sustain electrode 6 includes transparent electrode 6a serving as the second transparent electrode, and bus electrode 6b serving as the second bus electrode provided on transparent electrode 6a. Transparent electrode 5a includes second transparent electrode region 57 serving as a first base part, and first transparent electrode region 56 serving as a first projecting part which projects from second transparent electrode region 57 toward the discharge gap. Transparent electrode 6a includes second transparent electrode region 67 serving as a second base part, and first transparent electrode region 66 serving as a second projecting part which projects from second transparent electrode region 67 toward the discharge gap. Space D1 between the tip part of second transparent electrode region 57 on the side of the discharge gap and the tip part of bus electrode 5b on the side of the discharge gap is 5 μm to 20 μm. Furthermore, space D2 between the tip part of second transparent electrode region 67 on the side of the discharge gap and the tip part of bus electrode 6b on the side of the discharge gap is 5 μm to 20 μm.

In addition, each of the tip parts of first transparent electrode region 56 serving as the first projecting part and first transparent electrode region 66 serving as the second projecting part preferably includes a curve line. More specifically, each of the tip parts of first transparent electrode regions 56 and 66 may have a round shape. Radius φ assumed when a round part is regarded as a part of a circle preferably satisfies that 0≦φ≦d/2, wherein d represents a width of first transparent electrode regions 56 and 66. According to this configuration, the areas of first transparent electrode regions 56 and 66 around the discharge gap are further reduced. As a result, a capacitance between scan electrode 5 and scan electrode 5 can be reduced. Furthermore, a reactive power can be reduced by as much as 3% compared with the configuration in which each of the tip parts of first transparent electrode regions 56 and 66 does not include the curve line.

In addition, when each of the tip parts of first transparent electrode regions 56 and 66 is thinner than a part other than the tip part, the same or higher effect can be obtained.

In addition, the present invention is not limited to the first exemplary embodiment and the second exemplary embodiment. That is, the object of the present invention can be achieved as long as space D1 between the tip part of second transparent electrode region 57 on the side of the discharge gap and the tip part of bus electrode 5b on the side of the discharge gap is 5 μm to 20 μm, and space D2 between the tip part of second transparent electrode region 67 on the side of the discharge gap and the tip part of bus electrode 6b on the side of the discharge gap is 5 μm to 20 μm.

### INDUSTRIAL APPLICABILITY

The technique disclosed herein can improve a quality of the PDP, so that it can be useful for a display device having a large screen.

### REFERENCE MARKS IN THE DRAWINGS

1 front plate
2 rear plate
3 discharge space
4 front substrate
5 scan electrode
6 sustain electrode
5a, 6a transparent electrode
5b, 6b bus electrode
7 display electrode
8 dielectric layer
9 protective film
10 rear substrate
11 insulating layer
12 data electrode
13 barrier rib
13a vertical barrier rib
13b horizontal barrier rib
14R, 14G, 14B phosphor layer
15 discharge cell
21 PDP
22 image signal processing circuit
23 data electrode drive circuit
24 scan electrode drive circuit
25 sustain electrode drive circuit
26 timing generation circuit
56, 66 first transparent electrode region
57, 67 second transparent electrode region
200 plasma display device

1. A plasma display panel comprising:
a front plate; and
a rear plate opposed to the front plate, wherein the front plate has a first electrode, and a second electrode provided parallel to the first electrode, and a discharge gap is provided between the first electrode and the second electrode,
the first electrode includes a first transparent electrode and a first bus electrode provided on the first transparent electrode,
the second electrode includes a second transparent electrode and a second bus electrode provided on the second transparent electrode,
the first transparent electrode includes a first base part and first projecting parts projecting from the first base part toward the discharge gap,
the second transparent electrode includes a second base part and second projecting parts projecting from the second base part toward the discharge gap,
a space between a tip part of the first base part on a side of the discharge gap and a tip part of the first bus electrode on the side of the discharge gap ranges from 5 μm to 20 μm inclusive, and
a space between a tip part of the second base part on the side of the discharge gap and a tip part of the second bus electrode on the side of the discharge gap ranges from 5 μm to 20 μm inclusive.

2. The plasma display panel according to claim 1, wherein
each of tip parts of the first projecting part and the second projecting part includes a curve.

3. The plasma display panel according to claim 1, wherein
each of the first projecting part and the second projecting part projects only toward the discharge gap.

4. The plasma display panel according to claim 1, wherein a width L of each of the first and second projecting parts is equal to or greater than 14 or less than or equal to 20 and a width S between adjacent first projecting parts and adjacent second projecting parts is equal to or greater than 15 or less than or equal to 20.

5. The plasma display panel according to claim 1, wherein the first electrode and the second electrode of the front plate are provided on a dielectric layer, and a width S between adjacent first projecting parts and adjacent second projecting parts is greater than a film thickness of the dielectric layer.

6. A plasma display panel comprising:
a front plate; and
a rear plate opposed to the front plate, wherein
the front plate has a first electrode and a second electrode provided parallel to the first electrode so that a discharge gap is provided between the first electrode and the second electrode,
the first electrode includes a first transparent electrode and a first bus electrode provided on the first transparent electrode so that the first bus electrode is not in contact with the front plate,
the second electrode includes a second transparent electrode and a second bus electrode provided on the second transparent electrode so that the second bus electrode is not in contact with the front plate,
the first transparent electrode includes a first base part and first projecting parts projecting from the first base part toward the discharge gap,
the second transparent electrode includes a second base part and second projecting parts projecting from the second base part toward the discharge gap,
a space between a tip part of the first base part on a side of the discharge gap and a tip part of the first bus electrode on the side of the discharge gap ranges from 5 μm to 20 μm inclusive, and
a space between a tip part of the second base part on the side of the discharge gap and a tip part of the second bus electrode on the side of the discharge gap ranges from 5 μm to 20 μm inclusive.
